(19) United States
(12) Patent Application Publication
(10) Pub. No.: US 2011/0107976 A1
(43) Pub. Date: May 12, 2011

(54) For the birds

(76) Inventor: Darlene P. McFarland, Mobile, AL (US)

(21) Appl. No.: 12/590,424

(22) Filed: Nov. 9, 2009

(51) Int. Cl. A01K 29/00

(52) U.S. Cl. 119/174

(57) ABSTRACT

This invention relates to a squirrel or critter barrier device comprising two two-liter plastic bottles, stacked together, with holes drilled through the bottom and lid of each to provide for a wire or pole to go through the center, to be placed on the top or bottom of a bird feeder to prevent squirrel or critter passage.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

In most cases when hanging or setting up a bird feeder, one only wants it to be for the birds.

### BRIEF SUMMARY

It is the object of this invention to provide a barrier to keep squirrels or other critters from climbing along support cables to reach bird feeders. It is the further object of this invention to provide such a barrier that is long enough so that the squirrel or other critter does not simply reach past to traverse the length. Thereby leaving the birdseed for the birds.

### BRIEF DESCRIPTION OF THE SEVERAL VIEWS OF THE DRAWING

FIG. 1A is a view of where the holes should be drilled in the two-liter plastic bottles and lids.

FIG. 1B is a view of how the two-liter plastic bottles should be stacked.

FIG. 1C is a view of how the wire should be placed through the two, two-liter plastic bottles and lids.

FIG. 1D is a view of how both ends of the wire should be wrapped.

FIG. 1E is an elevation view of an animal barrier according to this invention mounted on a tree limb.

FIG. 2A is a view of where the holes should be drilled in the two-liter plastic bottles.

FIG. 2B is a view of how the two-liter plastic bottles should be stacked.

FIG. 2C is a view of how the wooden dowel should be placed through the two, two-liter plastic bottles.

FIG. 2D is a view of how both top ends of the bottles should be glued with wood glue to the wooden dowel.

FIG. 2E is an elevation view of the animal barrier according to this invention mounted on a stand leading to the bird feeder.

### DETAILED DESCRIPTION OF THE INVENTION

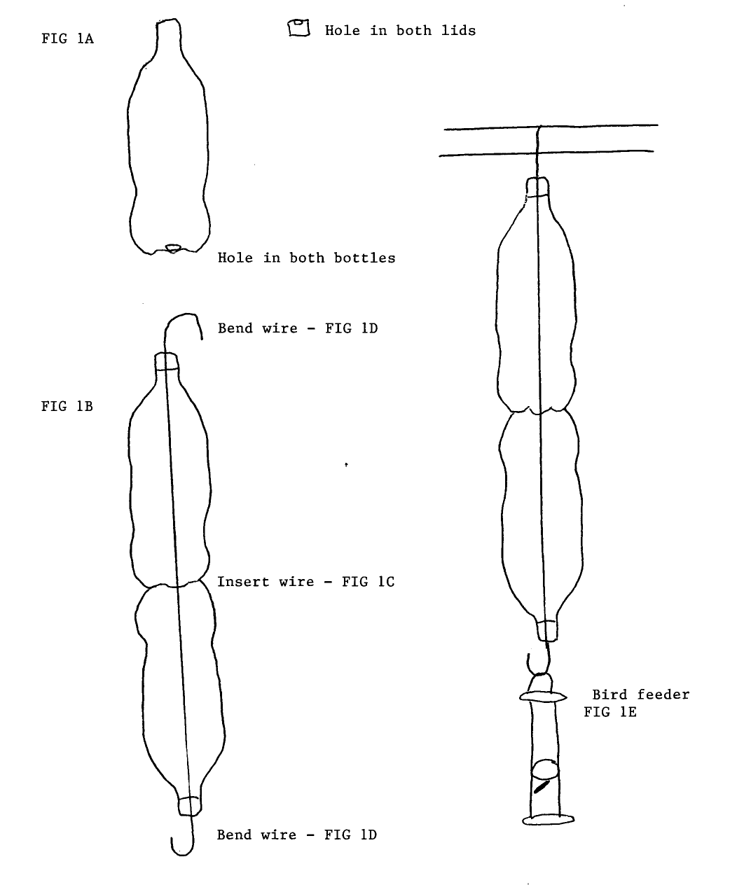

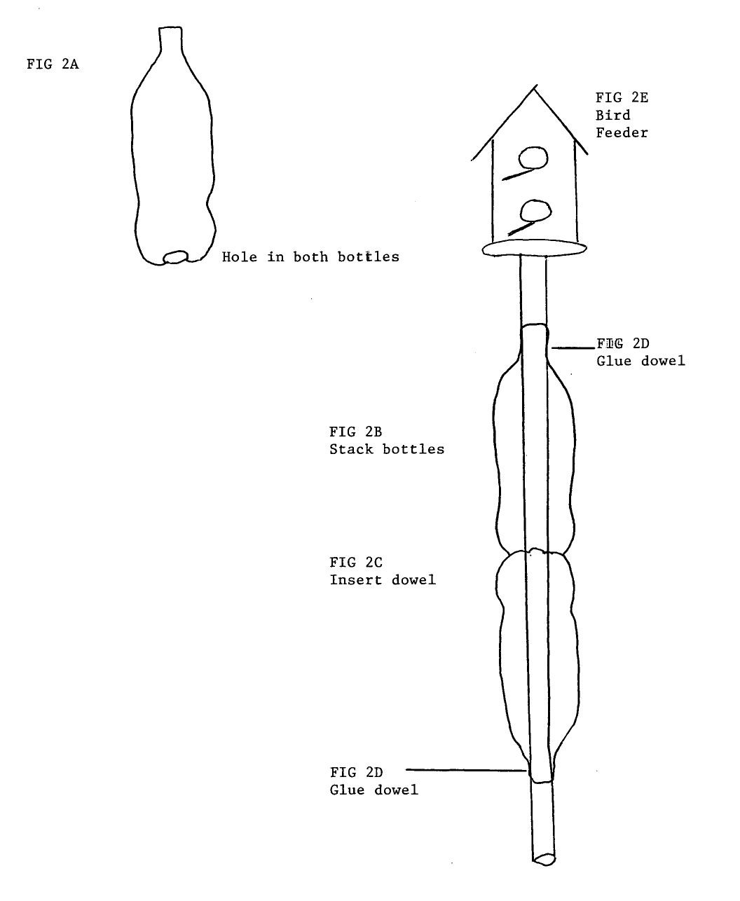

This invention may be accomplished by taking two empty two-liter plastic bottles. Then drill a hole in the bottom center of each bottle and lid, the size of the hole depends on the size of the wire (as shown in FIG. 1A) or wooden pole (as shown in FIG. 2A) being used. Stack the bottles on top of each other bottom to bottom (as shown in FIGS. 1B and 2B). Take a wire 36 inches long or a wooden pole of the desired length and run through both bottles (as shown in FIGS. 1C and 2C). Wrap one end of the wire on a tree branch where you intend to hang your bird feeder. Wrap the other end around the top of your bird feeder (as shown in FIG. 1D), or glue both top ends of the bottles to the wooden pole (as shown in FIG. 2D). Therefore, you will have the tree limb with the two bottles and then your bird feeder hanging (as shown in FIG. 1E), or your bird feeder on your wooden pole with the two bottles between the ground and the bird feeder attached to the pole (as shown in FIG. 2E). The two bottles stop any unwanted critters from getting to your birdseed.

1. A squirrel or critter barrier device, for mounting on a wire or pole to deter animal passage along the wire or pole, said device being formed by the placing of two plastic bottles together to provide the necessary length to create such barrier.
